(19) United States
(12) Patent Application Publication
(10) Pub. No.: US 2026/0064606 A1
(43) Pub. Date: Mar. 5, 2026

(54) Control-flow based Memory Access Manipulation For Isolating Code and Data

(71) Applicant: BLUEROCK SECURITY, INC., San Francisco, CA (US)

(72) Inventors: Sergej Proskurin, Munich (DE); Sebastian Wolfgang Vogl, Munich (DE); Jonas Pfoh, Radeberg (DE)

(21) Appl. No.: 19/316,643

(22) Filed: Sep. 2, 2025

Related U.S. Application Data
(60) Provisional application No. 63/689,807, filed on Sep. 2, 2024.

(51) Int. Cl. G06F 12/14; G06F 21/54; G06F 21/55

(52) U.S. Cl. CPC G06F 12/145; G06F 21/54; G06F 21/554

(57) ABSTRACT

Memory address boundaries of an isolated section of code and data is received from a guest in a virtualized system. One or more memory addresses that are legitimate entry points to the isolated section of code is received from the guest. One or more memory addresses that are each a return address of a call made from code in the isolated section into code that is not part of the isolated section is received from the guest. The host receives a second-level address translation (SLAT) violation during execution of a virtual central processing unit (vCPU) of the guest, where the first SLAT violation is associated with a memory address. The host determines that the first SLAT violation resulted from the vCPU attempting to access data in the isolated section of code and data and performs a remediation.

### CROSS-REFERENCE TO RELATED APPLICATIONS

This application claims the benefit of U.S. Provisional Application No. 63/689,807, filed Sep. 2, 2024, which is hereby incorporated by reference.

### FIELD

Embodiments of the invention relate to the field of virtualization; and more specifically, to control-flow based memory access manipulation for isolating code and data.

### BACKGROUND

Virtualization makes it possible for multiple operating systems (OSs) to run concurrently on a single host system without those OSs needing to be aware of the others. The single physical host machine is multiplexed into virtual machines (VMs) on top of which unmodified OSs (referred to as guest OSs) can run. Conventional implementations include a software abstraction layer between the hardware (which may support full virtualization) and the hosted operating system(s). The virtualization layer translates between virtual devices and the physical devices of the platform. In a fully virtualized environment, a guest operating system (OS) can run a virtual machine without any modifications and is typically unaware that it is being virtualized. Paravirtualization is a technique that makes a guest OS aware of its virtualization environment and requires hooks to a guest OS which requires access to its source code, or a binary translation be performed.

Although virtualization relies on hardware support, a software component called a microkernel runs directly on the hardware of the host machine and exposes the VM to the guest OS. The microkernel is typically the most privileged component of the virtual environment. The microkernel abstracts from the underlying hardware platform and isolates components running on top of it. A virtual machine monitor (VMM) manages the interactions between virtual machines and the physical resources of the host system. The VMM exposes an interface that resembles physical hardware to its virtual machine, thereby giving the guest OS the illusion of running on a bare-metal platform. As compared to the microkernel, the VMM is a deprivileged user component whereas the microkernel is a privileged kernel component.

There exist conventional ways of isolating memory. One way of isolating memory is to use full VM isolation. However, there can be overhead concerns of using full VM isolation. Another way of isolating memory is using containers such that each container has its own dedicated memory space. Compared to a full VM isolation solution, a container solution provides resource isolation without the need for a full VM and thus requires less overhead. However, these conventional container solutions rely on the kernel to provide isolation. Since all containers share the same kernel, if the kernel is compromised, the isolation of the container can also be compromised.

There are other conventional techniques for isolation. One technique uses second-level paging to isolate drivers in the kernel. Another technique uses hardware mechanisms that can be used to isolate memory. Another technique uses second-level paging to isolate sections of compiled binaries. Another technique uses second-level paging to isolate kernel and user portions of an address space. Another technique moves applications into a hypervisor protected address space. These solutions are either coarse grained (e.g., an entire application or driver is protected) or try to retrofit a solution onto an already built application.

### SUMMARY

Control-flow based memory access manipulation for isolating code and/or data is described. In one aspect, a host receives from a guest in a virtualized system, memory address boundaries of an isolated section of code and data, a first set of one or more memory addresses that are legitimate entry points to the isolated section of code, and a second set of one or more memory addresses that are each a return address of a call made from code in the isolated section into code that is not part of the isolated section. The host receives a first second-level address translation (SLAT) violation during execution of a virtual central processing unit (vCPU) of the guest, the first SLAT violation associated with a first memory address. The host determines at a time of the first SLAT violation that a SLAT table for the vCPU is configured in a first view where the isolated section of code and data is unmapped, and that the first SLAT violation resulted from the vCPU attempting to access data in the isolated section of code and data. Responsive to this determination, the host performs a remediation such as one or more of logging the first SLAT violation, injecting a general protection fault into the guest, rebooting the guest, and shutting down the guest.

An aspect may further include the host receiving a second SLAT violation during execution of the vCPU of the guest, the second SLAT violation associated with a second memory address. The host determines that at a time of the second SLAT violation that: the SLAT table for the vCPU is configured in the first view where the isolated section of code and data is unmapped, the second SLAT violation resulted from the vCPU attempting to transfer control to code in the isolated section of code and data, and the second memory address is not in the first set of memory addresses, not in the second set of memory addresses, and not in a third set of memory addresses where the vCPU is allowed to resume execution after an interrupt or dynamic call. The host performs a remediation responsive to this determination, such as one or more of logging the first SLAT violation, injecting a general protection fault into the guest, rebooting the guest, and shutting down the guest.

An aspect may further include the host receiving a third SLAT violation during execution of the vCPU of the guest, the third SLAT violation associated with a third memory address. The host determines at a time of the third SLAT violation that: the SLAT table for the vCPU is configured in the first view where the isolated section of code and data is unmapped, the third SLAT violation resulted from the vCPU attempting to transfer control to code in the isolated section of code and data, and the third memory address is in the first set of memory addresses. Responsive to this determination, the host performs operations including: switching a view of the SLAT table for the vCPU to a second view where the isolated section of code and data is mapped and all other code and data is unmapped, adding a return address associated with a transition that caused the third SLAT violation to the third set of one or more memory addresses, marking that the isolated section of code and data was entered by the vCPU, and returning control to the guest.

An aspect may further include the host receiving a fourth SLAT violation during execution of the vCPU of the guest, the fourth SLAT violation associated with a fourth memory address. The host determines at a time of the fourth SLAT violation that: the SLAT table for the vCPU is configured in the first view where the isolated section of code and data is unmapped, the fourth SLAT violation resulted from the vCPU attempting to transfer control to code in the isolated section of code and data, the fourth memory address is in the third set of memory addresses, and the isolated section of code and data is marked as being entered by the vCPU. Responsive to this determination, the host performs operations including: switching a view of the SLAT table for the vCPU to the second view, and returning control to the guest.

An aspect may further include the host receiving a fifth SLAT violation during execution of the vCPU of the guest, the fifth SLAT violation associated with a fifth memory address. The host determines at a time of the fifth SLAT violation that: the SLAT table for the vCPU is configured in the second view, the fifth SLAT violation resulted from the vCPU attempting to transfer control to code outside of the isolated section of code and data, and the fifth memory address is in the third set of memory addresses. Responsive to this determination, the host performs operations including: removing the fifth address from the third set of memory address, switching a view of the SLAT table for the vCPU to first view, and returning control to the guest.

An aspect may further include the host receiving a sixth SLAT violation during execution of the vCPU of the guest, the sixth SLAT violation associated with a sixth memory address. The host determines at a time of the sixth SLAT violation that: the SLAT table for the vCPU is configured in the second view, and the sixth SLAT violation resulted from the vCPU attempting to transfer control to code outside of the isolated section of code and data due to an interrupt. Responsive to this determination, the host performs operations including: adding a second return address to a fourth set of memory addresses, switching a view of the SLAT table for the vCPU to the first view, and returning control to the guest.

An aspect may further include receiving a seventh SLAT violation during execution of the vCPU of the guest, the seventh SLAT violation associated with a seventh memory address. The host determines at a time of the seventh SLAT violation that: the SLAT table for the vCPU is configured in the second view, the seventh SLAT violation resulted from the vCPU attempting to transfer control to code outside of the isolated section of code and data, and determining that the seventh memory address is in the fourth set of memory addresses. Responsive to this determination, the host performs operations including: removing the seventh address from the fourth set of memory addresses, switching a view of the SLAT table for the vCPU to the second view, and returning control to the guest.

### BRIEF DESCRIPTION OF THE DRAWINGS

The invention may best be understood by referring to the following description and accompanying drawings that are used to illustrate embodiments of the invention. In the drawings:

FIG. 1 is a block diagram that illustrates an exemplary architecture for a virtualized system for control-flow based memory access manipulation according to an embodiment.

FIG. 2 shows an example architecture for control-flow based memory access manipulation for isolating code and data according to an embodiment.

FIG. 3A shows the kernel image with an isolated section (code & data) according to an embodiment.

FIG. 3B shows the shows the guest virtual address space and the guest physical address space when the kernel is loaded according to an embodiment.

FIG. 3C shows the guest virtual address space and the guest physical address space when the kernel is loaded in the reference view according to an embodiment.

FIG. 3D shows the guest virtual address space and the guest physical address space when the kernel is loaded in the isolated section view according to an embodiment.

FIG. 4A is a flow diagram that illustrates a first portion of operations for responding to a SLAT violation for code and data isolation protection according to an embodiment.

FIG. 4B is a flow diagram that illustrates a second portion of operations for responding to the SLAT violation for code and data isolation according to an embodiment.

### DESCRIPTION OF EMBODIMENTS

Providing control-flow based memory access manipulation for isolating code and data in a virtualized system is described. This allows memory access permissions to be updated based on the control flow of a particular virtual central processing unit (vCPU). Hardware virtualization mechanisms (e.g., second-level paging/extended page tables) can be used to enforce access permissions of physical memory within the guest virtual machine. The current configuration of access permissions is updated as pre-configured entrance/exit gates are called by a particular vCPU.

In an embodiment, a developer can mark code and/or data of the kernel such that when compiled, the compiled code and data is co-located in an isolated section. The isolated code and/or data within an isolated section can reside in separate sections in memory had have different memory access permissions. In the complied binary, the code and data can be put into separate sections but they are logically part of the same isolated section. The developer can mark the legitimate entry points into the isolated code. These marked entry points are stored in a data structure, known herein as a static entry point data structure. A static analysis step is used to identify calls made from code in the isolated section into code that does not belong to the isolated section, where the return locations of these calls are added to a data structure known herein as a static return point data structure. The static return point data structure ensures that temporary code transitions, such as function calls, which leave the isolated section, can safely return to the isolated section upon their completion. In an embodiment, all the legitimate entry points to the isolated code section is determined without user interaction.

These entry points act as gatekeepers into the isolated section; any attempt to enter the isolated section through an instruction which is not in the set of static entry points, static return points, or dynamic return points (these will be described in detail later) will be remediated. Any attempt to access data within the isolated section while executing code outside of the isolated section will be remediated. At run time, each transition into the isolated section through a static entry point, is associated with a dynamic exit point, to which the host is allowed to return to, to exit the isolated section. Entering the isolated section can be regarded as transferring control flow to a black box; every time the host enters the black box, it will record the address, to which it is allowed to return to, as soon as the computation in that black box completes. These addresses are maintained by the host in a set of dynamic exit points. Exits to any other address will be remediated.

As an example, a legitimate code flow can be: (1) a call from outside the isolated section into an isolated section (at a memory address that is in the set of static entry points; and where the return address associated with the transition is added to the dynamic exit points); (2) a call from the isolated section to code outside of the isolated section (where the return address of this call is part of the static return points); (3) a return into the isolated section from the previous function call (at a memory address that is part of the static return points); and (4) a return to code outside of the isolated section that initially called into the isolated section (at an address in the dynamic exit points).

When the compiled kernel boots, the address bounds of the isolated section, and the set of static entry points and the set of static return points, is conveyed to the host, such as through a hypercall. This information is conveyed once at kernel initialization. Any subsequent attempts to communicate this information before the guest reboots generates an error case in the host, and is ignored. After receiving this information, the host creates a copy of the current second level address translation (SLAT) table for the vCPU. The host uses SLAT switching to change the mappings that are currently in use by a vCPU. In the first instance of the SLAT table, the isolated section of code and data is unmapped. This instance is referred to herein as the reference view. In the second instance of the SLAT table, the isolated section of code and data is mapped while all other code and data is unmapped. This instance is referred to herein as the isolated section view. The host begins by setting the SLAT table for all vCPUs to the reference view.

As the guest kernel executes, it will execute normally as long as it does not transfer control to code within the isolated section or access data within the isolated section. Throughout the execution several scenarios may occur.

A first scenario is if the vCPU's SLAT table is set to the reference view and it attempts to access data in the isolated section (which is not mapped in the reference view), which will result in a SLAT table violation and control will be transferred to the host. The host can determine that the current vCPU is operating in the reference view and has tried to access data in the isolated section and will remediate this behavior.

A second scenario is if the vCPU's SLAT table is set to the reference view and it attempts to transfer control to code in the isolated section (which is not mapped in the reference view), which results in a SLAT violation and control is transferred to the host. The host determines that the vCPU is operating in the reference view and has tried to transfer control to code in the isolated section. The host can determine whether the target address (the address in the isolated section where the vCPU is trying to execute code) is not in the set of static entry points and not in the set of static or dynamic return points. If the target address is not in the set of static entry and return points (static or dynamic), the host will remediate this behavior.

A third scenario is if the vCPU's SLAT table is set to the reference view and it attempts to transfer control to code in the isolated section (which is not mapped in the reference view), which results in a SLAT violation and control is transferred to the host. The host determines that the vCPU is operating in the reference view and has tried to transfer control to code in the isolated section. The host can determine whether the target address is in the set of static entry points. If the target address is in the set of static entry points, the host switches that vCPU's SLAT table to the isolated section view before transferring control back to the guest. After the host enters the isolated section view, it registers the associated exit point (the return address) in the set of dynamic exit points and marks that the isolated section was entered by this vCPU.

A fourth scenario is if the vCPU's SLAT table is set to the reference view and it attempts to transfer control to code in the isolated section (which is not mapped in the reference view), which results in a SLAT violation and control is transferred to the host. The host determines that the vCPU is operating in the reference view and has tried to transfer control to code in the isolated section. The host can determine whether the target address is in the set of return entry points. If the target address is in the set of return entry points, the host will switch that vCPU's SLAT table to the isolated section view before transferring control back to the guest, only if the isolated section was marked as entered by this vCPU. In the case that the transition was to a dynamic return point, this dynamic return point will be removed from the list of dynamic return points before control is handed back to the guest.

A fifth scenario is if the vCPU's SLAT table is set to the isolated section view and it attempts to transfer control to code outside of the isolated section (which is not mapped in the isolated section view), which results in a SLAT violation and control is transferred to the host. The host determines that the vCPU is operating in the isolated section view and has tried to transfer control to code outside of the isolated section. The host can determine whether this transition was due to an interrupt or due to normal control flow. In the latter case, the host determines if the target address is in the set of dynamic exit points and, if so, removes the address from the set of dynamic exit points, sets the vCPU's SLAT table to the reference view, and hands control back to the guest; otherwise, the unauthorized exit from the isolated section view is remediated. In addition, the host will mark the isolated section as having been left by this vCPU. In the former case, we must handle an interrupt from within the isolated section. This is described later herein.

A sixth scenario is if the vCPU's SLAT table is set to the isolated section view and it attempts to transfer control to code outside of the isolated section (which is not mapped in the isolated section view), which results in a SLAT violation and control is transferred to the host. The host determines that the vCPU is operating in the isolated section view and has tried to transfer control to code outside of the isolated section. The host can determine that this transition was caused by the interrupt. In this case, once the interrupt is handled, control will be handed back at the exact location it was interrupted. In this case, the host adds this address to the set of dynamic return points. A dynamic return point is a memory address where a vCPU is allowed to resume execution after an interrupt or dynamic call to code outside of the isolated section. The host then switches that vCPU's SLAT table to the reference view and hands control back to the guest.

As an example with respect to the Linux kernel, one or more isolated sections may be used to isolate the following subsystem: alternative instructions, jump labels, static calls, and static call keys. These subsystems are critical because they are capable of patching kernel code. Only code within the isolated section is allowed to patch code and pass all relevant security checks before code is updated. The isolated section may also be used to protect tracepoints. The tracepoint subsystem is used to legitimately set hooks in predefined locations of the kernel's code. In addition to potentially patching code, this subsystem maintains data structures with callbacks for each tracepoint location. Using the isolated section technique described herein, these data structures cannot be manipulated in a malicious fashion thereby allowing other security mechanisms that rely on these hooks to work securely.

Since well-defined entry points are specified prior to the execution of the software, embodiments ensure that security-critical actions taken within an isolated section, such as interactions with the virtualization host, are accessed only through predefined entry points. Certain checks are performed before any security-relevant actions are initiated. This mechanism guarantees that the necessary checks are executed beforehand as the code section is accessed solely via a predetermined code path. Should an attacker attempt to modify control flow to bypass these checks, the attempt to enter the protected region through an unauthorized entry point will be denied.

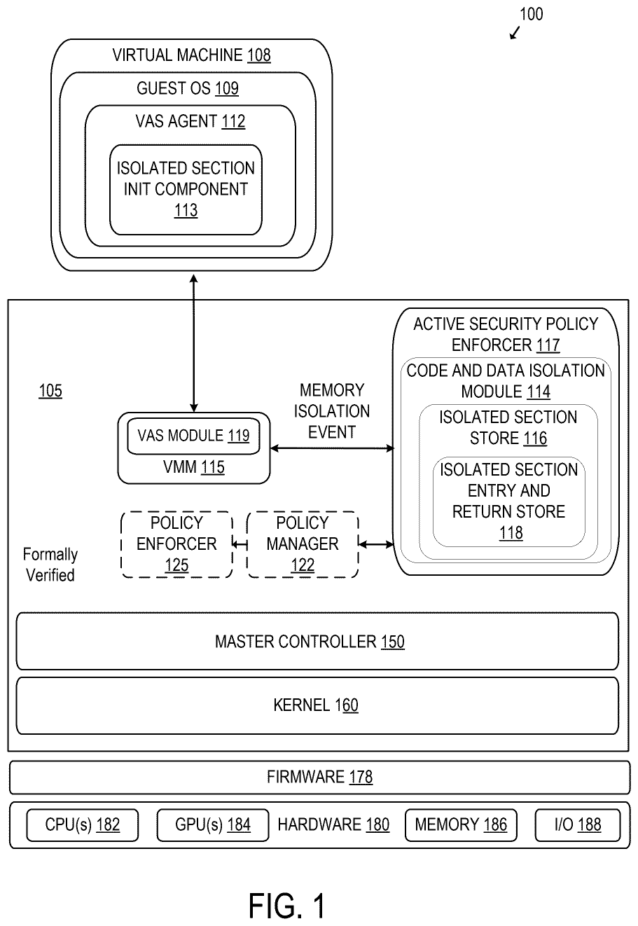

FIG. 1 is a block diagram that illustrates an exemplary architecture for a virtualized system for control-flow based memory access manipulation according to an embodiment. The computing device 100 may be any type of computing device such as a desktop computer, a laptop computer, a server computer, a mobile device such as a smartphone or tablet, a wearable device, a set-top box, a medical computing device, a gaming device, an internet-of-things (IoT) device, or any other computing device that can implement a virtualized system. The computing device 100 executes a hypervisor 105. The computing device 100 uses virtualization-assisted security (VAS). In a VAS system, the guest OS is enlightened (it is aware of the host and its services).

The virtualized system includes a guest operating system 109 that runs on top of the virtual machine 108. The guest OS 109 is modified to include the VAS agent 112 that leverages VAS features implemented in the VAS module 119 included in the VMM 115. The VAS agent 112 prepares the information needed for the VAS module 119 to implement the memory access permission features. For instance, the VAS agent 112 includes the isolated section initialization component 113 that communicates information to the host for the memory access permission features.

The VMM 115 may run as a user-level application in an address space on top of the kernel 160 and supports the execution of the guest OS 109 running in the VM 108. The VMM 115 manages the guest-physical memory of its associated virtual machine by mapping a subset of its own address space into the host address space of the VM 108. The VMM 115 can translate the guest virtual addresses to guest physical addresses. The VMM 115 can configure/modify access permissions of individual guest physical addresses in the system's second level address translation tables (slats).

The kernel 160 of the hypervisor 105 may be a lightweight microkernel running at the most privileged level as required by its role to abstract hardware resources (e.g., the CPU) with a minimum interface, and may have less than 10 kloc of code. Alternatively, the kernel 160 can be another type of kernel such as a monolithic kernel. The hardware 180 of the computing device 100 includes one or more central processing units (CPUs) 182, one or more graphics processing units (GPUs) 184, one or more memory units 186 (e.g., volatile memory such as SRAM or DRAM), and one or more input/output devices 188 such as one or more non-volatile storage devices, one or more human interface devices, etc. The hardware components are exemplary and there may be fewer pieces and/or different pieces of hardware included in the system. For instance, the hardware 180 may not include a GPU. Sitting atop the hardware 180 is the firmware 178. The firmware 178 may include CPU microcode, platform BIOS, etc.

The kernel 160 drives the interrupt controllers of the computing device 100 and a scheduling timer. The kernel 160 also controls the memory-management unit (MMU) and input-output memory-management unit (IOMMU) if available on the computing device 100. The kernel 160 may implement a capability-based interface. A capability is a reference to a resource, plus associated auxiliary data such as access permissions. A null capability does not refer to anything and carries no permissions. An object capability is stored in the object space of a protection domain and refers to a kernel object. A protection domain object capability refers to a protection domain. An execution context object capability refers to an execution context. A scheduling context object capability refers to a scheduling context. A portal object capability refers to a portal. A semaphore object capability refers to a semaphore. A memory object capability is stored in the memory space of a protection domain. An I/O object capability is stored in the I/O port space of a protection domain and refers to an I/O port. A guest space capability refers to a guest space.

Running on top of the kernel 160 are multiple hyper-processes. Each hyper-process runs as a separate protected and kernel 160 enforced memory and process space, outside of the privilege level of the kernel 160. In an embodiment, each hyper-process is formally verified. Some of these hyper-processes communicate with the kernel 160 such as the master controller 150. The master controller 150 controls the operation of the virtualization such as memory allocation, execution time allotment, virtual machine creation, and/or inter-process communication.

Active security with policy enforcement may be performed by the virtualized system according to an embodiment. For instance, control-flow based memory access manipulation for isolating code and data in the virtualized system may be performed. As shown in FIG. 1, the active security and policy enforcement may be performed in coordination with the policy manager 122 and one or more policy enforcers such as the active security policy enforcer 117 and policy enforcer 125. An active security policy enforces the behavior of a guest OS or guest application. Example active security policies include: code and data isolation, physical memory isolation, process credential protection, process allowance, process denial, driver allowance, driver denial, directory allowance, directory denial, file type allowance, file type denial, I/O device allowance, I/O device denial, limiting the number of writes to a particular register and/or limiting the values that can be in a particular register, and protecting a memory page (e.g., limiting writes or reads to specific memory pages, ensuring the memory is not executed). The code and data isolation is described in greater detail herein. As an example, a code and data isolation policy may determine whether an unauthorized action is to be logged or blocked.

The active security policy enforcer 117 includes the code and data isolation module 114. The code and data isolation module 114 uses hardware virtualization mechanisms (e.g., second-level paging tables) to enforce access permissions of physical memory within the guest VM 108. Thus, the host maintains memory access permissions that the guest cannot influence. The code and data isolation module 114 maintains data structure(s) for the code and data isolation. The isolated section store 116 includes the start and end addresses for all the isolated sections. The isolated section entry and return store 118 includes the entry and return points into those sections. For example, the isolated section entry and return store 118 can include a structure for a set of static entry points (e.g., the marked entry points) and include a structure for a set of static return points (the return locations of calls made from code in the isolated section into code that does not belong to the isolated section).

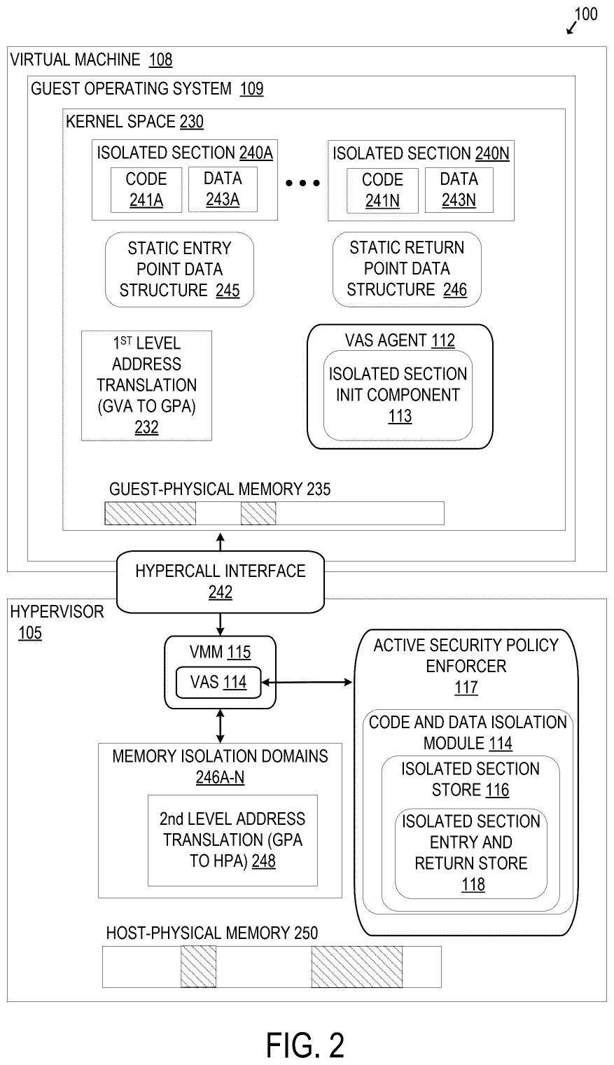

FIG. 2 shows an example architecture for control-flow based memory access manipulation for isolating code and data according to an embodiment. The guest OS 109 includes the kernel space 230. The kernel space 230 is where the kernel of the guest operating system 109 resides. The kernel space 230 includes a first level address translation 232 that translates between the guest-virtual memory and the guest-physical memory 235. Code (e.g., functions) and/or data of the kernel can be marked such that when compiled, the compiled code and data is isolated yet remain co-located within the address space of the kernel, which is referred herein as an isolated section. These isolated sections may be marked by the developer using compiler directives to indicate to the compiler that the code and data should be moved into a named section. The code and data in an isolated section can reside in separate sections in memory with different memory access permissions. In the example of FIG. 2, there are the isolated sections 240A-N that include the code 241A-N and data 243A-N respectively. In addition, the legitimate entry points into the isolated code may be marked and stored in a data structure called the static entry point data structure 245. These entry points may be marked by the developer using compiler directives where each entry point is effectively a call to a function. These functions can be marked with compiler directives that store the offset of the function in a separate section (e.g., entry and return store). Static analysis, such as during the build process of the kernel, is used to identify any calls made from code in an isolated section into code that does not belong to that isolated section. The return locations of these calls are added to an additional data structure, referred to as the static return point data structure 246. The set of static entry point(s) and the set of static return point(s) are stored within the binary executable that is generated by the compiler.

The kernel boots and early in its initialization, it informs the host of the isolated section boundaries and the set of static entry point(s) and the set of static return point(s) via a hypercall. The isolated section boundaries may or may not be contiguous. The guest can send a list of boundaries that belong to the same isolated section. Thus, the isolated section initialization component 113 of the VAS agent 112 informs the host, via a hypercall using the hypercall interface 242, of the isolated section boundaries of the isolated sections 240A-N, the static entry point data structure 245, and the static return point data structure 246. After this hypercall is made, any subsequent attempts to update this data by the guest is ignored. Thus, the kernel has one chance to inform the host of this information and once done, the data is immutable.

The host creates the memory isolation domains 246A-N based on the information received from the isolated section initialization component 113. A memory isolation domain is represented by a set of guest-physical memory page frames/ranges that are to be protected by the associated domain. A memory isolation domain includes a set of second-level address translation (SLAT) tables represented by the SLAT table 248 in FIG. 2. The SLAT table 248 translates guest-physical addresses to host-physical addresses of the host-physical memory 250. The SLAT table 248 can be an extended page table (EPT), a nested page table (NPT), or a stage 2 page table, for example. Thus, the host maintains memory access permissions that the guest cannot influence. Further, the host can maintain a separate second-level address translation (SLAT) table per vCPU such that a vCPU executing outside of the isolated section cannot access data inside of the isolated section, even if another vCPU is operating inside of the isolated section.

The code and data isolation module 114 can use SLAT switching to change the mappings that are currently in use by a vCPU. After the host receives the isolated section boundaries and the set of static entry point(s) and the set of static return point(s), the code and data isolation module 114 creates a copy of the current SLAT table. In the first instance of the SLAT table, the isolated section of code and data is unmapped. This instance is referred to herein as the reference view. For each isolated section, there is a second instance of the SLAT table where the isolated section of code and data is mapped while all other code and data is unmapped. This instance is referred to herein as the isolated section view. The reference view is the base SLAT table and each isolated section view has a separate SLAT table. The code and data isolation module 114 begins by setting the SLAT table for all CPUs to the reference view. The code and data isolation module 114 can switch between the reference view and an isolated section view for isolation the code and data. For example, a pointer (e.g., a register in the physical CPU that holds the address of the SLAT table to be used) can be used to change between the reference view SLAT table and the isolated section view SLAT table.

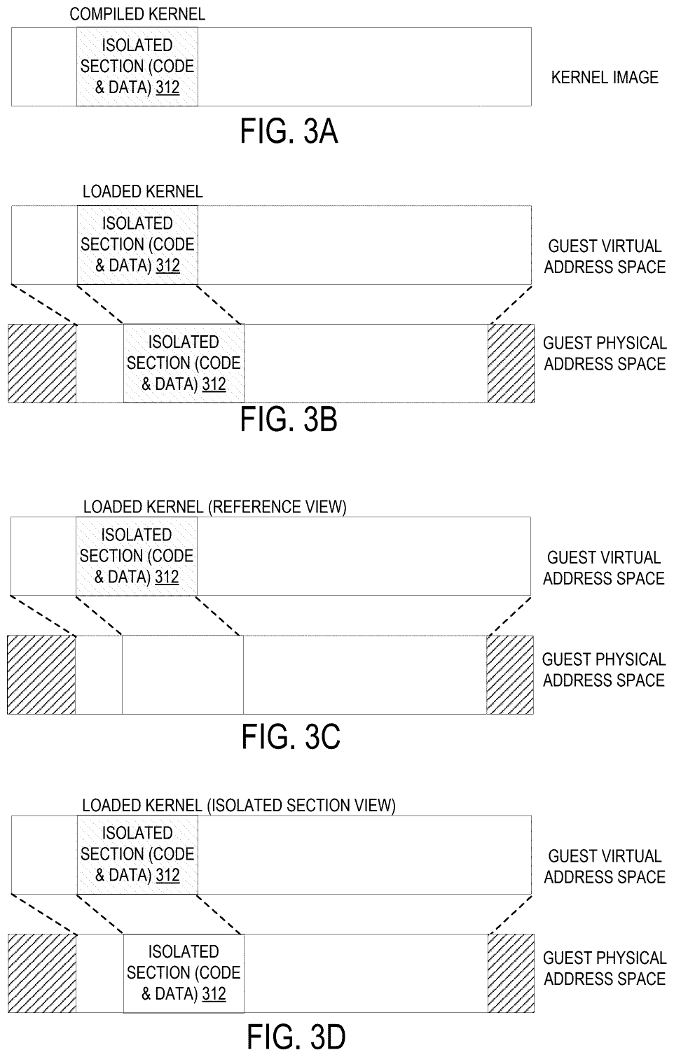

FIGS. 3A-3D illustrate examples of the different views. FIG. 3A shows the kernel image with an isolated section (code & data) 312. FIG. 3B shows the guest virtual address space and the guest physical address space when the kernel is loaded. FIG. 3C shows the guest virtual address space and the guest physical address space when the kernel is loaded in the reference view. As shown in FIG. 3C, the isolated section (code and data) 312 is unmapped (it is not mapped to the guest physical address space). FIG. 3D shows the guest virtual address space and the guest physical address space when the kernel is loaded in the isolated section view. As shown in FIG. 3D, the isolated section (code and data) 312 is mapped while the other code and data of the kernel is unmapped.

As the guest kernel executes, it will execute normally as long as it does not transfer control to code within the isolated section or access data within the isolated section. The code and data isolation module 114 responds to SLAT violations, which can occur because the guest kernel tries to access a page that is not mapped in the SLAT, the guest kernel tries to perform an operation it does not have permission for, or if the guest kernel tries to access a memory area that does not exist or has been deallocated.

The code and data isolation module 114 responds to a SLAT violation depending on the current state of the SLAT table for the vCPU (e.g., whether it is in reference view or isolation section view) and the nature of the SLAT violation. The code and data isolation module 114 may remediate behavior as appropriate, which can be one or more of: logging the violation, injecting a general protection fault into the guest, rebooting the guest, and shutting down the guest.

SLAT Violations when in the Reference View

If the SLAT table for the vCPU is set to the reference view and the vCPU attempts to access data in the isolated section (which is not mapped in the reference view), a SLAT violation occurs and control is transferred to the host. The code and data isolation module 114 determines that the vCPU is operating in the reference view and has tried to access data in the isolated section. After this determination, the code and data isolation module 114 will remediate this behavior.

If the SLAT table for the vCPU is set to the reference view and the vCPU attempts to transfer control to code in the isolated section (which is not mapped in the reference view), a SLAT violation occurs and control is transferred to the host. The code and data isolation module 114 determines that the vCPU is operating in the reference view and has tried to transfer control to code in the isolated section. The code and data isolation module 114 determines whether the address being transferred is in the set of static entry points or whether the address being transferred is in the set of static or dynamic return points.

If the address being transferred is not in the set of static entry points and not in the set of static or dynamic return points, the code and data isolation module 114 will remediate this behavior.

If the address being transferred is in the set of static entry points, the code and data isolation module 114 will switch the SLAT for the vCPU to the isolated section view and will transfer control back to the guest. The code and data isolation module 114 will register the associated exit point (the return address) in the set of dynamic exit points and mark that the isolated section was entered by this vCPU.

If the address being transferred is not in the set of static entry points but is in the set of static or dynamic return points, the code and data isolation module 114 will switch the SLAT for the vCPU to the isolated section view only if the isolated section is marked as being entered by this vCPU, and will transfer control back to the guest. If the isolated section is not marked as being entered by this vCPU, then the code and data isolation module 114 will remediate this behavior. In the case that this step represents a successful transition into a dynamic return point, that dynamic return point is removed from the data structure.

SLAT Violations when in the Isolated Section View

If the SLAT table for the vCPU is set to the isolated section view and the vCPU attempts to transfer control to code outside of the isolated section, a SLAT violation occurs and control is transferred to the host. The code and data isolation module 114 determines that the vCPU is operating in the isolated section view and has tried to transfer control to code outside of the isolated section. The code and data isolation module 114 determines whether this transition was due to an interrupt or due to normal control flow.

If the transition was due to normal control flow, the code and data isolation module 114 determines whether the target address is in the set of dynamic exit points. If the target address is in the set of dynamic exit points, the code and data isolation module 114 removes the address from the set of dynamic exit points, sets the SLAT table for the vCPU to the reference view, marks the isolated section as having been exited by this vCPU, and hands control back to the guest. If the target address is not in the set of dynamic exit points (which is an unauthorized exit from the isolated section view), the code and data isolation module 114 remediates the behavior.

If the transition was due to an interrupt, once the interrupt is handled, control will be handed back at the exact location it was interrupted. The code and data isolation module 114 adds this address to an additional data structure called dynamic return points. The code and data isolation module 114 then switches the SLAT table for the vCPU to the reference view and hands control back to the guest.

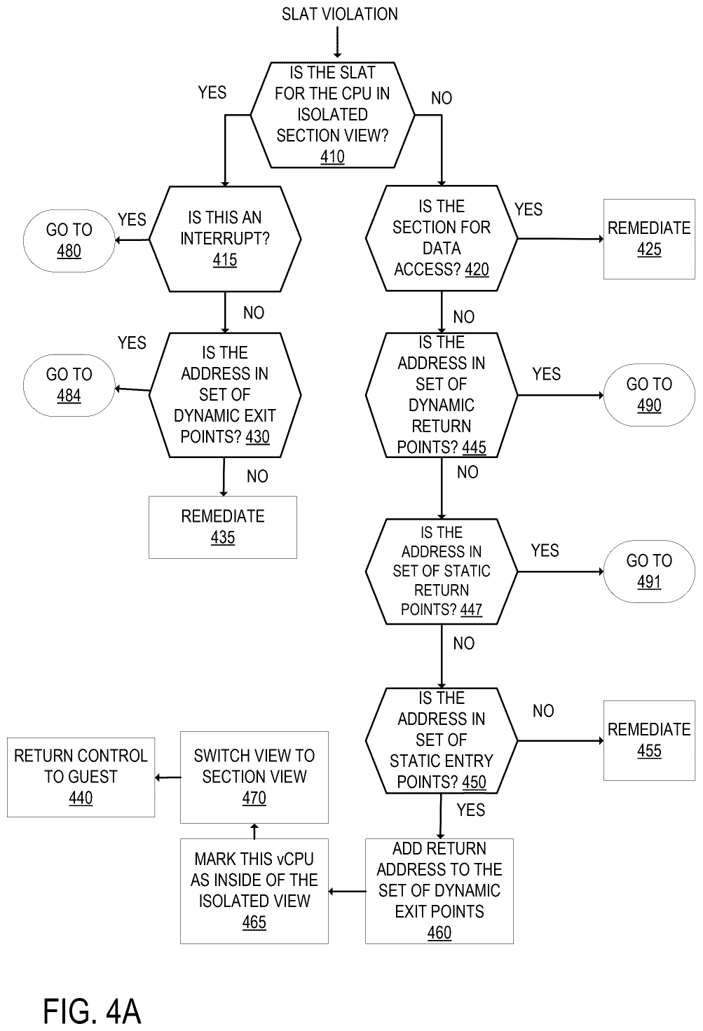

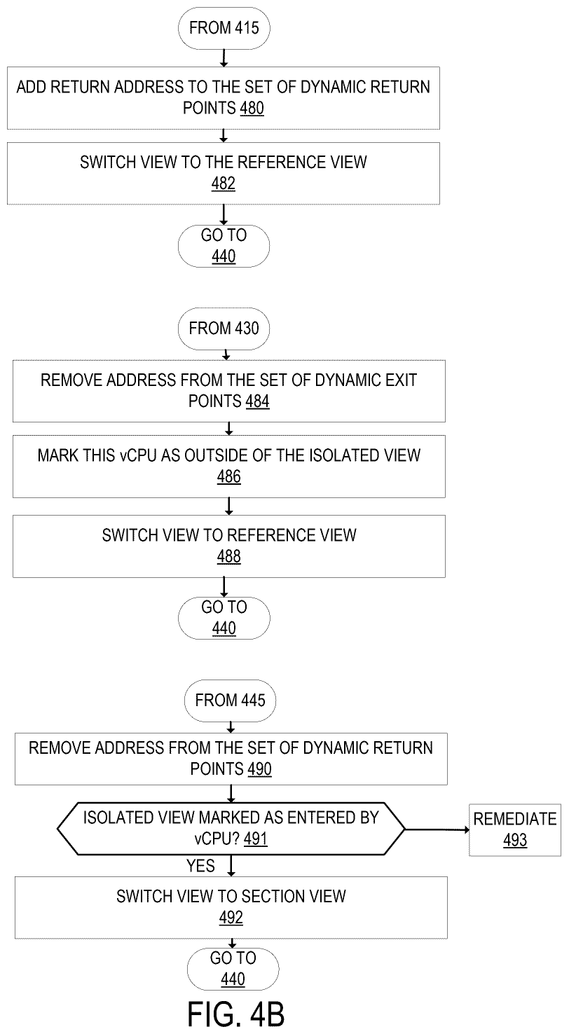

FIG. 4A is a flow diagram that illustrates a first portion of operations for responding to a SLAT violation for code and data isolation protection; and FIG. 4B is a flow diagram that illustrates a second portion of operations for responding to the SLAT violation for code and data isolation according to an embodiment. The operations begin with a SLAT violation. The response of the host varies depending on the current state of the SLAT table for the vCPU and the nature of the SLAT violation.

At operation 410, the code and data isolation module 114 determines whether the SLAT violation is for a SLAT table for the vCPU that is in isolated section view. The code and data isolation module 114 checks the state of the SLAT table for the vCPU to determine whether it is in isolated section view or reference view. If the SLAT table for the vCPU is in isolated section view, then operation 415 is performed. If the vCPU is not in isolated section view (e.g., it is in reference view), then operation 420 is performed.

At operation 415, the code and data isolation module 114 determines whether the transition was due to an interrupt. If it was, then operation 480 is performed. Once the interrupt is handled, control will be handed back at the exact location it was interrupted. At operation 480 the code and data isolation module 114 adds the address to the dynamic return points data structure. Next, at operation 482, the code and data isolation module 114 switches the SLAT table for the vCPU to the reference view and returns control back to the guest at operation 440.

If the transition was not due to an interrupt (e.g., it was due to normal control flow), then operation 430 is performed. At operation 430, the code and data isolation module 114 determines whether the target address is in the set of dynamic exit points. If the target address is in the set of dynamic exit points, then operation 484 is performed. At operation 484, the code and data isolation module 114 removes the address from the set of dynamic exit points. Next, at operation 486, the code and data isolation module 114 marks the vCPU as outside of the isolated view. Next, at operation 488, the code and data isolation module 114 sets the SLAT table for the vCPU to the reference view, and hands control back to the guest at operation 440. If the target address is not in the set of dynamic exit points (which is an unauthorized exit from the isolated section view), the host will remediate at operation 435.

Referring back to operation 410, if the vCPU is not in isolated section view (e.g., it is in reference view), then operation 420 is performed. At operation 420, the code and data isolation module 114 determines whether the violation is related to an attempt to access data in the isolated section. If it is, then at operation 425 the code and data isolation module 114 remediates this behavior. If the violation is not related to an attempt to access data in the isolated section (e.g., it is referring to an attempt to transfer control to code in the isolated section), then operation 445 is performed.

At operation 445, the code and data isolation module 114 determines whether the address being transferred is in the set of dynamic return points. If it is, then operation 490 is performed. At operation 490, the code and data isolation module 114 removes the address that is being transferred from the set of dynamic return points. Next, at operation 491, the code and data isolation module 114 determines whether the isolated section view is marked as entered by this vCPU. If not, the action is remediated at operation 493. If the isolated section is marked as entered by this vCPU, then operation 492 is performed. At operation 492, the code and data isolation module 114 sets the SLAT table for the vCPU to the isolated section view, and returns control back to the guest at operation 440.

If the address being transferred is not in the set of dynamic return points, then operation 447 is performed. At operation 447, the code and data isolation module 114 determines whether the address being transferred is in the set of static return points. If it is, then operation 491 is performed as described previously. If the address being transferred is not in the set of static return points, then operation 450 is performed.

At operation 450, the code and data isolation module 114 determines whether the address being transferred is in the set of static entry points. If it is not, then operation 455 is performed where the code and data isolation module 114 remediates the behavior. If the address being transferred is in the set of static entry points, then operation 460 is performed.

At operation 460, the code and data isolation module 114 adds the return address to the set of dynamic exit points. The return address is the address stored on the top of the stack in an x86 architecture, or stored in a specific register in an Aarch64 architecture. At operation 465, the code and data isolation module 114 marks the vCPU as inside of the isolated section. Next, at operation 470, the code and data isolation module 114 sets the SLAT table for the vCPU to the isolated section view, and hands control back to the guest at operation 440.

If the address being transferred is not in the set of static entry points but is in the set of static return points, the code and data isolation module 114 will switch the SLAT for the vCPU to the isolated section view only if the isolated section is marked as being entered by this vCPU, and will transfer control back to the guest. If the isolated section is not marked as being entered by this vCPU, then the code and data isolation module 114 will remediate this behavior.

Embodiments described herein allow code and data to be co-located such that only the code that should be updating the data can do so. In addition, control flow integrity is provided as the isolated code is only permitted to be entered through pre-defined entry points. An attempt to execute any of the isolated code without going through these pre-defined entry points will result in remediation.

Data and the code that legitimately acts on that data can be co-located such that an attempt to update the data from any other location within the code is not possible. This prevents any malicious code that was loaded into the address space from accessing the data. It also prevents any code reuse attacks from accessing this data. For example, the techniques described herein can be used to protect the tracepoint subsystem of the Linux kernel. Tracepoints are used by some security software to place legitimate hooks into the kernel's control flow. Further, these tracepoints may be stored in the kernel as a linked list of data structures that contain the callback functions. The ability to directly manipulate this linked list or the data structures contained therein can compromise the security software's ability to do its job. Attackers may try to load code into kernel that manipulate these data structures directly. However, the techniques described herein prevent such direct manipulation of this data

Co-locating code and data ensures that only the code within the isolated section can update the related data. However the code within the isolated section can manipulate the data, so what if an attacker simply calls into the isolated section in order for the isolated code to manipulate the data on their behalf? In order to combat this, the code within the isolated section performs checks to ensure the validity of the update to the data and if these checks fail, the update is not performed. However, without well defined entry points, an attacker could simply transfer control to the part of the code that performs the update while skipping the security critical checks that must happen first. In order to combat such attacks, we maintain our list of valid entry points. Calling into these valid entry points will ensure that the security relevant checks are always carried out before an update to the data takes place. Any attempt to transfer control into the isolated section outside of a valid entry point is rejected by the host.

The exemplary architecture shown in the Figures can be used in different hardware architectures including ARM architectures and x86 architectures. ARM defines different levels of privilege as exception levels. Each exception level is numbered, and the higher levels of privilege have higher numbers. Exception level 0 (EL0) is known as the application privilege level. All the hypervisor components except for the kernel 160 are in the exception level 0. Applications executing within the virtual machines are also in exception level 0. The OS kernels executing within the virtual machines are in exception level 1 (EL1), which is the rich OS exception level. The kernel 160 is in exception level 2 (EL2), which is the hypervisor privilege level. The firmware 178 and the hardware 180 are at exception level 3 (EL3), which is the firmware privilege level and the highest privilege level. The x86 architecture defines four protection rings but most modern architectures use two privilege levels, rings 0 and 3 and may run in guest or host mode. For instance, a guest OS kernel running in a virtual machine runs in the most privileged level (guest kernel mode, ring 0), and the guest applications run in a lesser privileged level (guest user mode, ring 3). The kernel 160 runs in the most privileged level of the host (host kernel mode, ring 0), and the other components of the hypervisor run in a lesser privileged level (host user mode, ring 3).

Multiple components of the virtualization layer are formally verified components in some embodiments. Formal verification proves (or disproves) the correctness of intended code using formal methods of mathematics. Formal verification guarantees that a system is free of programming errors.

The techniques shown in the figures can be implemented using code and data stored and executed on one or more computing devices. Such computing devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals—such as carrier waves, infrared signals, digital signals). In addition, such computing devices typically include a set of one or more hardware processors coupled to one or more other components, such as one or more I/O devices (e.g., storage devices (non-transitory machine-readable storage media), a keyboard, a touchscreen, a display, and/or network connections). The coupling of the set of processors and other components is typically through one or more busses and bridges (also termed as bus controllers). Thus, the storage device of a given computing device typically stores code and/or data for execution on the set of one or more processors of that computing device.

In the preceding description, numerous specific details are set forth to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the preceding description and the claims, the terms “coupled” and “connected,” along with their derivatives, may be used. These terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

While the flow diagrams in the figures show a particular order of operations performed by certain embodiments of the invention, such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method, comprising:
receiving, from a guest in a virtualized system, memory address boundaries of an isolated section of code and data, a first set of one or more memory addresses that are legitimate entry points to the isolated section of code, and a second set of one or more memory addresses that are each a return address of a call made from code in the isolated section into code that is not part of the isolated section;
receiving a first second-level address translation (SLAT) violation during execution of a virtual central processing unit (vCPU) of the guest, the first SLAT violation associated with a first memory address; and
determining at a time of the first SLAT violation that a SLAT table for the vCPU is configured in a first view where the isolated section of code and data is unmapped, and that the first SLAT violation resulted from the vCPU attempting to access data in the isolated section of code and data, and responsive to this determination, performing a first remediation.

2. The method of claim 1, further comprising:
receiving a second SLAT violation during execution of the vCPU of the guest, the second SLAT violation associated with a second memory address;
determining that at a time of the second SLAT violation that:
the SLAT table for the vCPU is configured in the first view where the isolated section of code and data is unmapped,
the second SLAT violation resulted from the vCPU attempting to transfer control to code in the isolated section of code and data, and
the second memory address is not in the first set of memory addresses, not in the second set of memory addresses, and not in a third set of memory addresses where the vCPU is allowed to resume execution after an interrupt or dynamic call; and
responsive to this determination, performing a second remediation.

3. The method of claim 1, further comprising:
receiving a second SLAT violation during execution of the vCPU of the guest, the second SLAT violation associated with a second memory address;
determining at a time of the second SLAT violation that:
the SLAT table for the vCPU is configured in the first view where the isolated section of code and data is unmapped,
the second SLAT violation resulted from the vCPU attempting to transfer control to code in the isolated section of code and data, and
the second memory address is in the first set of memory addresses; and
responsive to this determination, performing operations including:
switching a view of the SLAT table for the vCPU to a second view where the isolated section of code and data is mapped and all other code and data is unmapped,
adding a return address associated with a transition that caused the second SLAT violation to a third set of one or more memory addresses, the third set of one or more memory addresses comprising one or more memory addresses where the vCPU is allowed to resume execution after an interrupt or dynamic call,
marking that the isolated section of code and data was entered by the vCPU, and
returning control to the guest.

4. The method of claim 1, further comprising:
receiving a second SLAT violation during execution of the vCPU of the guest, the second SLAT violation associated with a second memory address;
determining at a time of the second SLAT violation that:
the SLAT table for the vCPU is configured in the first view where the isolated section of code and data is unmapped,
the second SLAT violation resulted from the vCPU attempting to transfer control to code in the isolated section of code and data,
the second memory address is in a third set of one or more memory addresses, the third set of one or more memory addresses comprising one or more memory addresses where the vCPU is allowed to resume execution after an interrupt or dynamic call, and
the isolated section of code and data is marked as being entered by the vCPU; and
responsive to this determination, performing operations including:
switching a view of the SLAT table for the vCPU to a second view where the isolated section of code and data is mapped and all other code and data is unmapped, and
returning control to the guest.

5. The method of claim 1, further comprising:
receiving a second SLAT violation during execution of the vCPU of the guest, the second SLAT violation associated with a second memory address;
determining at a time of the second SLAT violation that:
the SLAT table for the vCPU is configured in a second view where the isolated section of code and data is mapped and all other code and data is unmapped,
the second SLAT violation resulted from the vCPU attempting to transfer control to code outside of the isolated section of code and data, and
the second memory address is in a third set of one or more memory addresses, the third set of one or more memory addresses comprising one or more memory addresses where the vCPU is allowed to resume execution after an interrupt or dynamic call; and
responsive to this determination, performing operations including:
removing the second memory address from the third set of memory addresses,
switching a view of the SLAT table for the vCPU to first view, and
returning control to the guest.

6. The method of claim 1, further comprising:
receiving a second SLAT violation during execution of the vCPU of the guest, the second SLAT violation associated with a second memory address;
determining at a time of the second SLAT violation that:
the SLAT table for the vCPU is configured in a second view where the isolated section of code and data is mapped and all other code and data is unmapped, and
the second SLAT violation resulted from the vCPU attempting to transfer control to code outside of the isolated section of code and data due to an interrupt;
responsive to this determination, performing operations including:
adding a second return address to a fourth set of memory addresses, the fourth set of memory addresses comprising memory addresses where the vCPU is allowed to resume execution within the isolated section after an interrupt,
switching a view of the SLAT table for the vCPU to the first view, and
returning control to the guest.

7. The method of claim 1, further comprising:
receiving a second SLAT violation during execution of the vCPU of the guest, the second SLAT violation associated with a second memory address;
determining at a time of the second SLAT violation that:
the SLAT table for the vCPU is configured in a second view where the isolated section of code and data is mapped and all other code and data is unmapped,
the second SLAT violation resulted from the vCPU attempting to transfer control to code outside of the isolated section of code and data, and
determining that the second memory address is in a fourth set of memory addresses, the fourth set of memory addresses comprising memory addresses where the vCPU is allowed to resume execution within the isolated section after an interrupt; and
responsive to this determination, performing operations including:
removing the second memory address from the fourth set of memory addresses,
switching a view of the SLAT table for the vCPU to the second view, and
returning control to the guest.

8. The method of claim 1, wherein performing the first remediation includes one or more of: logging the first SLAT violation, injecting a general protection fault into the guest, rebooting the guest, and shutting down the guest.

9. A computing device that implements a virtualized system, comprising:
a processor; and
a non-transitory machine-readable storage medium that provides instructions that, if executed by the processor cause the computing device to carry operations including:
receiving, from a guest in the virtualized system, memory address boundaries of an isolated section of code and data, a first set of one or more memory addresses that are legitimate entry points to the isolated section of code, and a second set of one or more memory addresses that are each a return address of a call made from code in the isolated section into code that is not part of the isolated section,
receiving a first second-level address translation (SLAT) violation during execution of a virtual central processing unit (vCPU) of the guest, the first SLAT violation associated with a first memory address, and
determining at a time of the first SLAT violation that a SLAT table for the vCPU is configured in a first view where the isolated section of code and data is unmapped, and that the first SLAT violation resulted from the vCPU attempting to access data in the isolated section of code and data, and responsive to this determination, performing a first remediation.

10. The computing device of claim 9, wherein the operations further include:
receiving a second SLAT violation during execution of the vCPU of the guest, the second SLAT violation associated with a second memory address;
determining that at a time of the second SLAT violation that:
the SLAT table for the vCPU is configured in the first view where the isolated section of code and data is unmapped,
the second SLAT violation resulted from the vCPU attempting to transfer control to code in the isolated section of code and data, and
the second memory address is not in the first set of memory addresses, not in the second set of memory addresses, and not in a third set of memory addresses where the vCPU is allowed to resume execution after an interrupt or dynamic call; and
responsive to this determination, performing a second remediation.

11. The computing device of claim 9, wherein the operations further include:
receiving a second SLAT violation during execution of the vCPU of the guest, the second SLAT violation associated with a second memory address;
determining at a time of the second SLAT violation that:
the SLAT table for the vCPU is configured in the first view where the isolated section of code and data is unmapped,
the second SLAT violation resulted from the vCPU attempting to transfer control to code in the isolated section of code and data, and
the second memory address is in the first set of memory addresses; and
responsive to this determination, performing operations including:
switching a view of the SLAT table for the vCPU to a second view where the isolated section of code and data is mapped and all other code and data is unmapped,
adding a return address associated with a transition that caused the second SLAT violation to a third set of one or more memory addresses, the third set of one or more memory addresses comprising one or more memory addresses where the vCPU is allowed to resume execution after an interrupt or dynamic call,
marking that the isolated section of code and data was entered by the vCPU, and
returning control to the guest.

12. The computing device of claim 9, wherein the operations further include:
receiving a second SLAT violation during execution of the vCPU of the guest, the second SLAT violation associated with a second memory address;
determining at a time of the second SLAT violation that:
the SLAT table for the vCPU is configured in the first view where the isolated section of code and data is unmapped,
the second SLAT violation resulted from the vCPU attempting to transfer control to code in the isolated section of code and data,
the second memory address is in a third set of one or more memory addresses, the third set of one or more memory addresses comprising one or more memory addresses where the vCPU is allowed to resume execution after an interrupt or dynamic call, and
the isolated section of code and data is marked as being entered by the vCPU; and
responsive to this determination, performing operations including:
switching a view of the SLAT table for the vCPU to a second view where the isolated section of code and data is mapped and all other code and data is unmapped, and
returning control to the guest.

13. The computing device of claim 9, wherein the operations further include:
receiving a second SLAT violation during execution of the vCPU of the guest, the second SLAT violation associated with a second memory address;
determining at a time of the second SLAT violation that:
the SLAT table for the vCPU is configured in a second view where the isolated section of code and data is mapped and all other code and data is unmapped,
the second SLAT violation resulted from the vCPU attempting to transfer control to code outside of the isolated section of code and data, and
the second memory address is in a third set of one or more memory addresses, the third set of one or more memory addresses comprising one or more memory addresses where the vCPU is allowed to resume execution after an interrupt or dynamic call; and
responsive to this determination, performing operations including:
removing the second memory address from the third set of memory addresses,
switching a view of the SLAT table for the vCPU to first view, and
returning control to the guest.

14. The computing device of claim 9, wherein the operations further include:
receiving a second SLAT violation during execution of the vCPU of the guest, the second SLAT violation associated with a second memory address;
determining at a time of the second SLAT violation that:
the SLAT table for the vCPU is configured in a second view where the isolated section of code and data is mapped and all other code and data is unmapped, and
the second SLAT violation resulted from the vCPU attempting to transfer control to code outside of the isolated section of code and data due to an interrupt;
responsive to this determination, performing operations including:
adding a second return address to a fourth set of memory addresses, the fourth set of memory addresses comprising memory addresses where the vCPU is allowed to resume execution within the isolated section after an interrupt,
switching a view of the SLAT table for the vCPU to the first view, and
returning control to the guest.

15. The computing device of claim 9, wherein the operations further include:
receiving a second SLAT violation during execution of the vCPU of the guest, the second SLAT violation associated with a second memory address;
determining at a time of the second SLAT violation that:
the SLAT table for the vCPU is configured in a second view where the isolated section of code and data is mapped and all other code and data is unmapped,
the second SLAT violation resulted from the vCPU attempting to transfer control to code outside of the isolated section of code and data, and
determining that the second memory address is in a fourth set of memory addresses, the fourth set of memory addresses comprising memory addresses where the vCPU is allowed to resume execution within the isolated section after an interrupt; and
responsive to this determination, performing operations including:
removing the second memory address from the fourth set of memory addresses,
switching a view of the SLAT table for the vCPU to the second view, and
returning control to the guest.

16. The computing device of claim 9, wherein performing the first remediation includes one or more of: logging the first SLAT violation, injecting a general protection fault into the guest, rebooting the guest, and shutting down the guest.

17. A non-transitory machine-readable storage medium that provides instructions that, if executed by a processor of a computing device that implements a virtualized system, will cause the computing device to perform operations including:
receiving, from a guest in the virtualized system, memory address boundaries of an isolated section of code and data, a first set of one or more memory addresses that are legitimate entry points to the isolated section of code, and a second set of one or more memory addresses that are each a return address of a call made from code in the isolated section into code that is not part of the isolated section;
receiving a first second-level address translation (SLAT) violation during execution of a virtual central processing unit (vCPU) of the guest, the first SLAT violation associated with a first memory address; and
determining at a time of the first SLAT violation that a SLAT table for the vCPU is configured in a first view where the isolated section of code and data is unmapped, and that the first SLAT violation resulted from the vCPU attempting to access data in the isolated section of code and data, and responsive to this determination, performing a first remediation.

18. The non-transitory machine-readable storage medium of claim 17, wherein the operations further include:
receiving a second SLAT violation during execution of the vCPU of the guest, the second SLAT violation associated with a second memory address;
determining that at a time of the second SLAT violation that:
the SLAT table for the vCPU is configured in the first view where the isolated section of code and data is unmapped,
the second SLAT violation resulted from the vCPU attempting to transfer control to code in the isolated section of code and data, and
the second memory address is not in the first set of memory addresses, not in the second set of memory addresses, and not in a third set of memory addresses where the vCPU is allowed to resume execution after an interrupt or dynamic call; and
responsive to this determination, performing a second remediation.

19. The non-transitory machine-readable storage medium of claim 17, wherein the operations further include:
receiving a second SLAT violation during execution of the vCPU of the guest, the second SLAT violation associated with a second memory address;
determining at a time of the second SLAT violation that:
the SLAT table for the vCPU is configured in the first view where the isolated section of code and data is unmapped,
the second SLAT violation resulted from the vCPU attempting to transfer control to code in the isolated section of code and data, and
the second memory address is in the first set of memory addresses; and
responsive to this determination, performing operations including:
switching a view of the SLAT table for the vCPU to a second view where the isolated section of code and data is mapped and all other code and data is unmapped,
adding a return address associated with a transition that caused the second SLAT violation to a third set of one or more memory addresses, the third set of one or more memory addresses comprising one or more memory addresses where the vCPU is allowed to resume execution after an interrupt or dynamic call,
marking that the isolated section of code and data was entered by the vCPU, and
returning control to the guest.

20. The non-transitory machine-readable storage medium of claim 17, wherein the operations further include:
receiving a second SLAT violation during execution of the vCPU of the guest, the second SLAT violation associated with a second memory address;
determining at a time of the second SLAT violation that:
the SLAT table for the vCPU is configured in the first view where the isolated section of code and data is unmapped,
the second SLAT violation resulted from the vCPU attempting to transfer control to code in the isolated section of code and data,
the second memory address is in a third set of one or more memory addresses, the third set of one or more memory addresses comprising one or more memory addresses where the vCPU is allowed to resume execution after an interrupt or dynamic call, and
the isolated section of code and data is marked as being entered by the vCPU; and
responsive to this determination, performing operations including:
switching a view of the SLAT table for the vCPU to a second view where the isolated section of code and data is mapped and all other code and data is unmapped, and
returning control to the guest.

21. The non-transitory machine-readable storage medium of claim 17, wherein the operations further include:
receiving a second SLAT violation during execution of the vCPU of the guest, the second SLAT violation associated with a second memory address;
determining at a time of the second SLAT violation that:
the SLAT table for the vCPU is configured in a second view where the isolated section of code and data is mapped and all other code and data is unmapped,
the second SLAT violation resulted from the vCPU attempting to transfer control to code outside of the isolated section of code and data, and
the second memory address is in a third set of one or more memory addresses, the third set of one or more memory addresses comprising one or more memory addresses where the vCPU is allowed to resume execution after an interrupt or dynamic call; and
responsive to this determination, performing operations including:
removing the second memory address from the third set of memory addresses,
switching a view of the SLAT table for the vCPU to first view, and
returning control to the guest.

22. The non-transitory machine-readable storage medium of claim 17, wherein the operations further include:
receiving a second SLAT violation during execution of the vCPU of the guest, the second SLAT violation associated with a second memory address;
determining at a time of the second SLAT violation that:
the SLAT table for the vCPU is configured in a second view where the isolated section of code and data is mapped and all other code and data is unmapped, and
the second SLAT violation resulted from the vCPU attempting to transfer control to code outside of the isolated section of code and data due to an interrupt;
responsive to this determination, performing operations including:
adding a second return address to a fourth set of memory addresses, the fourth set of memory addresses comprising memory addresses where the vCPU is allowed to resume execution within the isolated section after an interrupt,
switching a view of the SLAT table for the vCPU to the first view, and
returning control to the guest.

23. The non-transitory machine-readable storage medium of claim 17, wherein the operations further include:
receiving a second SLAT violation during execution of the vCPU of the guest, the second SLAT violation associated with a second memory address;
determining at a time of the second SLAT violation that:
the SLAT table for the vCPU is configured in a second view where the isolated section of code and data is mapped and all other code and data is unmapped,
the second SLAT violation resulted from the vCPU attempting to transfer control to code outside of the isolated section of code and data, and
determining that the second memory address is in a fourth set of memory addresses, the fourth set of memory addresses comprising memory addresses where the vCPU is allowed to resume execution within the isolated section after an interrupt; and
responsive to this determination, performing operations including:
removing the second memory address from the fourth set of memory addresses,
switching a view of the SLAT table for the vCPU to the second view, and
returning control to the guest.

24. The non-transitory machine-readable storage medium of claim 17, wherein performing the first remediation includes one or more of: logging the first SLAT violation, injecting a general protection fault into the guest, rebooting the guest, and shutting down the guest.
